(19) United States
(12) Patent Application Publication
(10) Pub. No.: US 2023/0222320 A1
(43) Pub. Date: Jul. 13, 2023

(54) SIGNAL RECOVERY METHOD

(71) Applicant: Petróleo Brasileiro S.A. - Petrobras, Rio de Janeiro (BR)

(72) Inventor: Bernardo Pereira Foresti, Rio de Janeiro (BR)

(21) Appl. No.: 18/146,078

(22) Filed: Dec. 23, 2022

(30) Foreign Application Priority Data
Dec. 27, 2021 (BR) 10 2021 026560 4

(51) Int. Cl. G06N 3/0442; G06N 3/048; G06N 3/063

(52) U.S. Cl. CPC G06N 3/0442; G06N 3/048; G06N 3/063

(57) ABSTRACT

The present invention deals with an intelligent system capable of modeling a sensor from data from other sensors related to the same machine or process where the sensor is included. The models used are within the context of machine learning. Memory models (preferably LSTM and GRU networks) and neural networks (preferably MLP) models were used. After training the model via error minimization, data from a faulty sensor can be estimated from the model and written into monitoring systems such as historian softwares. Accordingly, continuous monitoring of the operational condition of machines and industrial processes is made possible.

### CROSS-REFERENCE TO RELATED APPLICATION

This application claims priority to Brazilian Application No. BR 10 2021 026560 4, filed on Dec. 27, 2021, and entitled “SIGNAL RECOVERY METHOD,” the disclosure of which is incorporated herein by reference in its entirety.

### FIELD OF THE INVENTION

The present invention is related to the field of the continuous monitoring of industrial process parameters, where the history of several measured variables is followed, such as temperatures, pressures, valve positions, shaft speed in the case of rotating machines, vibration, electrical current of engines, etc. Servers that carry out this monitoring store several years of the history of such variables.

### DESCRIPTION OF THE STATE OF THE ART

The technical problem that motivated the invention was the need for a continuous monitoring of industrial process parameters, since the sensors that provide the data often fail. In these circumstances, production monitoring of industrial processes and machines is compromised.

At PETROBRAS the production systems are continuously monitored, for example, through historian softwares (HS). On such a platform, it is possible to monitor the history of several measured variables, such as temperatures, pressures, valve positions, shaft speed in the case of rotating machines, vibration, electrical current from engines, etc. Several years of history of such variables are stored on the HS servers. One of the most used historian softwares is the PI Process Book (PI).

In possession of the same, several systems and specialists seek to detect anomalies, such as: leaks, incrustations, severe slugging, paraffin, pump surging, compressor stall, among others.

Despite its great relevance for monitoring the production, it is not uncommon for the sensors that provide data to the HS to fail. In these circumstances, production monitoring is compromised. There is therefore a need to seek for estimates for the physical quantities that are no longer accessible through simulators. Simulators are commonly used, which in turn use models based on the physics of the problem to estimate values that the failing sensors should measure. These models are very complex and are not fully developed, causing uncertainty in the estimates, as taught by FORESTI, 2020 (FORESTI, B. P. Estimação de fração de gás no bombeio centrífugo submerso utilizando sinais de vibração. Doctoral dissertation, UNICAMP, Campinas, SP. 2020).

Document CN113486950 A discloses an intelligent pipe network water leakage detection method and the invention is also related to a system for implementing the method.

Document US2020394351 A1 discloses an operation and maintenance (O&M) system, and related method for a plurality of unique objects characterized by distinct digital twins.

Document EP3250965 B1 discloses a method for detecting sensor error in a system with a plurality of subsystems and a number of sensors associated with these subsystems, each sensor producing at least one respective sensor output.

The state of the art pointed out by the cited documents does not disclose the recovery of signals in defective sensors nor does it teach how to allow the industrial process operations to continue with faulty sensors. In addition, the cited documents also do not allow the detection of anomalies in processing plants, with faulty sensors of critical parameters.

Thus, the state of the art does not present any solutions capable of solving the problems caused by faulty sensors, which causes interruption of industrial process operations and also the detection of anomalies in processing plants.

### OBJECT OF THE INVENTION

It is an object of the invention to provide a solution to the problem of faulty sensors.

It is a second objective of the invention to allow industrial process operations to proceed with faulty sensors.

It is a third objective of the invention to detect anomalies in processing plants, even with faulty sensors.

### BRIEF DESCRIPTION OF THE INVENTION

The invention acts on the estimation of variables of faulty sensors through data-driven models using a machine learning technique. The developed method benefits from the fact that there is a long history of variables stored on the HS. With this history, several input/output relationships can be searched for. The models developed by the present invention are formed by two layers, the first of which being composed of a recurrent neural network (LSTM- — Long Short Term Memory or GRU — Gated Recurrent Unit) and the second by multilayer perceptrons. With the use of such models synthetic, low-error signals could be generated, providing monitoring of the production. The technique is shown to be a viable alternative for monitoring faulty sensors.

### BRIEF DESCRIPTION OF THE DRAWINGS

The present invention will be described in more detail below, with reference to the attached figures which, in a schematic and non-limiting manner of the scope of the invention, represent examples of embodiments. In the drawings:

FIG. 1 illustrates a prediction plot for pressure (P) of the TPT of a wet christmas tree from an oil and natural gas producing wellbore (pressure in Kgf/cm² x time in day/hour), where number 1 shows the line that represents the variable indicated by the HS and number 2 shows the line that represents the prediction variable of the model of the invention;

FIG. 2 illustrates a prediction plot of the temperature (T) of the TPT of a wet christmas tree from an oil and natural gas producing wellbore (temperature in °C x time in day/hour), where number 3 shows the line that represents the variable indicated by the HS and number 4 shows the line that represents the prediction variable of the model of the invention;

FIG. 3 illustrates the graph of the pressure and temperature sensors of the wet christmas tree of an oil and gas producing wellbore, where number 5 shows the line that represents the pressure variable and number 6 shows the line that represents the temperature variable, indicating failure in the pressure and temperature sensors (temperature and pressure values in °C and kgf/cm² x days);

FIG. 4 illustrates graphs showing the learning curve for pressure and temperature of the wet christmas tree TPT (MSE x season). The acronym MSE stands for Mean Squared Error, the number of seasons corresponds to the number of times that the total data of a training set (referred to in the figure as “tr”) is presented to the model for training. When training the model, for monitoring the MSE, a data set for cross-validation was also used (referred to in the same figure as “cv”) ;

FIG. 5 illustrates graphs showing the estimated error in the set of tests for pressure and temperature of the wet christmas tree TPT (number of operating points x absolute error);

FIG. 6 shows a graph of operating points with the absolute error in kgf/cm² referring to an application of the method to the first gas-lift wellbore;

FIG. 7 shows a graph of pressure in kgf/cm² x time (day and time) for the first gas lift wellbore, where it can be noted that the actual measurement (solid line) is exactly the same as the prediction (dotted line) for the considered time interval;

FIG. 8 shows a graph of pressure in kgf/cm² x time (day and time) for the first gas lift wellbore, where it can be noted that the actual measurement (solid line) is exactly the same as the prediction (dotted line) for the considered time interval;

FIG. 9 shows the graph of the number of operating points with the absolute error (in °C) for the second gas-lift wellbore;

FIG. 10 shows the graph of temperature (°C) over time (day and hour) with the actual (solid) and prediction (dotted) lines for the second gas-lift wellbore;

FIG. 11 shows the graph of temperature (°C) over time (day and hour) with real (solid) and predicted (dotted) lines, with data from test 2 (T_TPT in failure): Jan. 01, 2021 -Mar. 26, 2021 (3 months) for the second gas lift wellbore.

### DETAILED DESCRIPTION OF THE INVENTION

Below is a detailed description of a preferred embodiment of the present invention, which is given by way of example and is in no way limiting. Nevertheless, possible additional embodiments of the present invention still comprised by the essential and optional features below will be clear to a person skilled in the art from reading this description.

The method consists of training a neural network to predict process data, such as temperature, pressure, vibration, etc. The raw data is first filtered in order to remove spurious data. They are then segmented into sections with N data, wherein N=100 in the tests performed proved to be optimum (therefore N values different than 100 for scenarios other than the one tested are not excluded) . The architecture with the best result is composed of a recurrent neural network layer of the LSTM type (for the pressure signal) or GRU type (for the temperature signal) with 30 neurons, connected to an MLP type layer (multilayer perceptron) having 100 neurons (100 neurons because N=100. If a different period was intended to be predicted, the number of neurons would be different). The FRNN - Fully Recurrent Neural Network was also assessed in replacement to the LSTM and GRU, but for the examples shown the results were better with LSTM and GRU, but for other different scenarios FRNN is not excluded. Other non-linear models were tested to replace the MLP, as follows: Support Vector Machine, Neural Networks with Radial Basis Activation Function, Extreme Learning Machines, Echo State Neural Networks, but for the examples shown the results were worse (therefore, its use for scenarios different than those tested is not excluded). The recurrent network activation function was of the hyperbolic tangent type and linear MLP. A linear function is f (x) = A.x b, wherein A and b are constants. The recurrent networks function as memory models and together with the MLP were able to capture the non-linearities of data and their interdependence. When using the model for prediction, the arithmetic mean of the predictions of overlapping sections is also performed. In addition to the arithmetic mean, other meta models were used, for example, Support Vector Machine, Neural Networks with Radial Basis Activation Function, Extreme Learning Machines, Echo State Neural Networks and K-nearest neighbors. The best results for the tested scenario were obtained with the arithmetic mean, but further meta models for scenarios other than the one tested should not be excluded.

The cross-validation method used was the holdout (GERON, A. Hands-On Machine Learning with Scikit-Learn, Keras, and TensorFlow: Concepts, Tools, and Techniques to Build Intelligent Systems. [S.1.]: O′Reilly Media, 2019) . Data (that is, the sequence obtained by HS) was normalized by the arithmetic mean and standard deviation prior to the training in order to facilitate optimization. The optimization method used was Adam’s, a stochastic method that considers the gradient of the previous iteration (KINGMA, D. P.; BA, J. Adam: A method for stochastic optimization. arXiv preprint arXiv: 1412.6980, 2014).

Historical measurement data within a suitable interval for use in the method is used for evaluation of the trained model (test set). Data equivalent to a period of about 2 years were used for training, sampled at 1/30 S/s (samples per second). In some instances, shorter duration data (on the order of just a few days) with a higher acquisition rate (on the order of ⅓ S/s) was used.

The signal recovery method comprises the following steps:
1. selecting the process measurement variable;
2. collecting historical measurement data of the process variable;
3. filtering spurious components and segmenting the samples into intervals with N data;
4. using the recurrent neural network layer connected to a multilayer perceptron layer;
5. using the activation function of recurrent networks preferably, a hyperbolic tangent, but linear, sigmoid, ReLu and Leaky ReLu functions can also be used;
6. using the multilayer perceptron layer activation function preferably of linear type, but sigmoid, hyperbolic tangent, ReLu, leaky ReLu functions can also be used;
7. using the hold-out, k-fold or leave-one-out cross validation method.
8. normalizing the filtered data by the arithmetic mean and standard deviation, or between any two values, or by forcing the normal statistical distribution, or applying any linear transformation to the data, such as Main Component Analysis before training;
9. using an optimization method for training the model;
10.using the HS to generate a sequence with input data referring to the time frame one wants the model to perform the prediction;
11.filtering said sequence to withdraw spurious components and segment the samples into N data intervals;
12. normalizing this sequence to the arithmetic mean and standard deviation;
13.displaying the sequence to the model;
14. If there some segments overlap, calculating the arithmetic mean, applying another linear meta model (such as a linear regression, a weighted average, for example), or a non-linear meta model (such as a neural network, a support vector regression, for example );
15. writing the results in a HS-monitored variable or in a graph. The best results for items 3 and 11 were obtained with N=100. The best results as to the number of neurons (step 4) were obtained when using a recurrent neural network layer with 30 neurons connected to a multilayer perceptron layer with 100 neurons.

### EXAMPLES

The following examples are presented to fully illustrate the nature of the present invention and how to practice the same, without, however, being considered limitative of its content.

### Example-1

The example of application of the method used in the present invention consists of training a neural network to predict pressure (P) and temperature (T) data from the TPT of the christmas tree of an oil and natural gas producing wellbore.

For the training, data between Jan. 01, 2018 and Nov. 17, 2019 were used, which were divided into two sets, a training set and another ser for cross-validation, containing, respectively, 80 and 20% of the total data. The cross-validation method used was the holdout, in which optimization is interrupted when the MSE assessed in the cross-validation set starts to increase. This is made to reduce overfitting errors. Data was normalized by the arithmetic mean and standard deviation prior to training in order to facilitate optimization. The optimization method used was that of Adam (KINGMA; BA, 2014).

Data between Nov. 18, 2019 and Jan. 26, 2020 was used to assess the trained model (test set). During this period, the P and T sensors were still functioning properly. Data acquisition frequency is 1/30 S/s.

The input variables chosen from the christmas tree were:
a) PDG: P, T;
b) Choke: P, T (upstream and downstream) and % opening;
c) Tubing-. P and T;
d) Flowline: P.

The TPT output variables were P and T. Test data: Nov. 18, 2019 to Jan. 26, 2020 (~2 months). The acquisition rate was 1/30 S/s. The LSTM was selected with 30 neurons and a hyperbolic tangent-type activation function with the addition of MLP with 100 linear neurons.

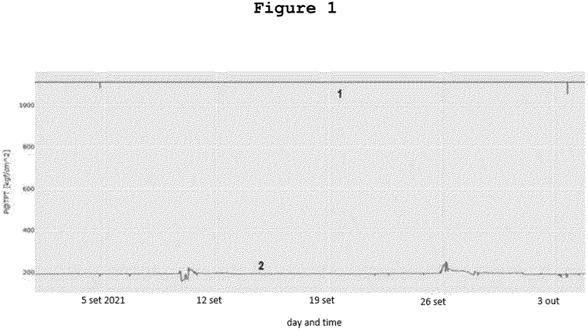

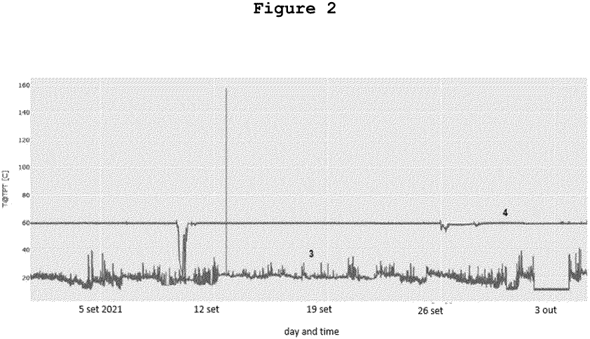

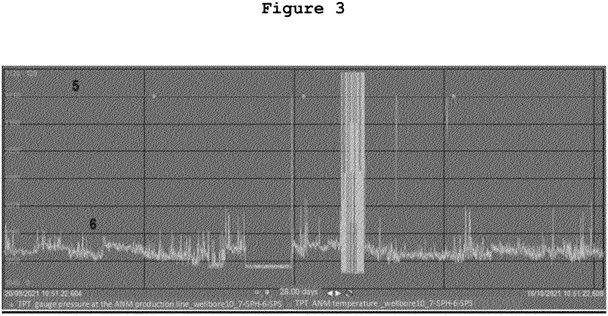

FIG. 3 shows the graph showing the faulty temperature and pressure sensors of the wet christmas tree. FIG. 1 and FIG. 2 show the results of applying the trained prediction models, respectively, for P and T in the TPT. The low error in the test set combined with the active engineering analysis confirms the effectiveness of the method for estimating data from defective sensors. It is worth emphasizing that the method developed by the present invention is not restricted to oil exploitation and production applications and can be used for any process where a sensor fails to measure a certain variable, enabling machine operations and industrial processes to continue and also the detection of anomalies in industrial plants even when the sensors fail.

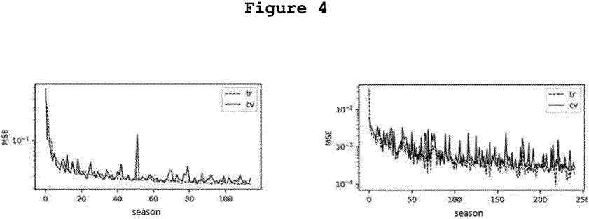

FIG. 4 shows learning curves of trained models for P and T, respectively. It should be noted that the MSE decays for the two sets of training (“tr”) and cross validation (“cv”) . Training stops when the MSE of the cross-validation set increases consecutively for 30 seasons. The optimal parameters are when the MSE of the “cv” set is minimum. It can be seen in this figure that the MSE of “tr” and “cv” sets declined, indicating that the network “learned” with the data and that the MSEs of such sets are sufficiently close, showing low overfitting error.

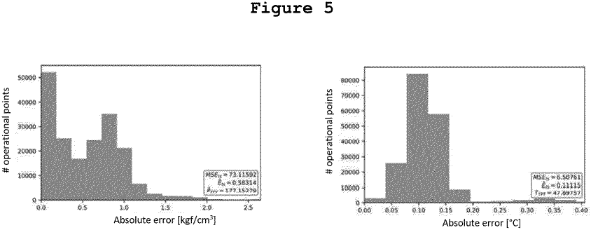

FIG. 5 discloses the histograms of absolute errors obtained when comparing the values measured by the sensors and the values estimated by the P and T models, respectively. It can be seen in both graphs that the absolute error is close to zero for most points.

### Example-2

The following examples resulted from the application of the method of the present invention in two gas lift wellbores, and consists of training a neural network to predict pressure (P) and temperature (T) data from the TPT. EXAMPLE-2. 1:

The input variables were:
1. PDG: T
2. TPT: P, T
3. Upstream choke: P, T
4. Downstream choke: P, T

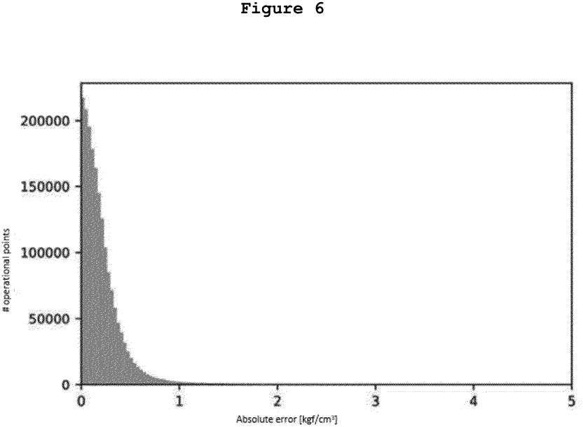

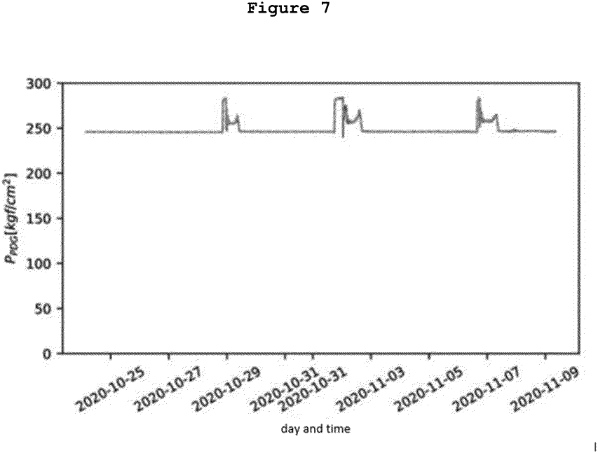

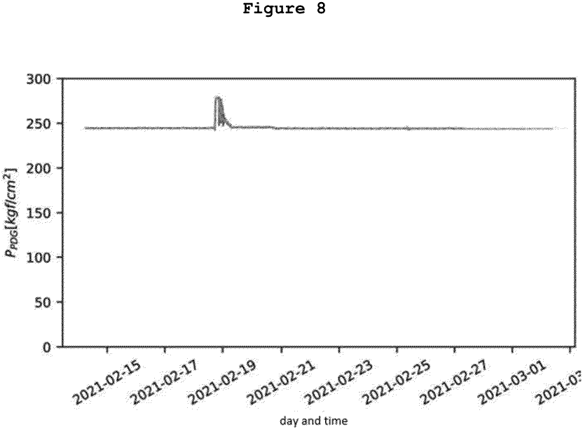

The output variable was the PDG Pressure. Training data refer to the period from Jan. 01, 2019 to Oct. 08, 2020 (1 year and 9 months). Test data (P_PDG functional) referring to period from Oct. 08, 2020 to Mar. 18, 2021 (5 months). The acquisition rate was 1/30 S/s. The model used was the LSTM (tanh, sigmoid, 20 neurons), MLP (linear, 100 neurons). FIG. 6 shows a graph of operating points with absolute error in kgf/cm², with MSEts = 0.33325, Ets = nan and Ppdg = 248.26633. FIGS. 7 and 8 show a graph of pressure in kgf/cm² x time (day and time), where it can be noted that the actual measurement (solid line) is exactly the same as the prediction (dotted line) for the considered time. Thus, the developed method was able to reproduce the actual status of operation in the gas lift wellbore in terms of pressure.

An advantage of using the disclosed method for such a gas lift wellbore was the identification of transient regimes that could not be missed in the course of modeling.

### Example-2.2

For another gas lift wellbore the input variables were:
1. PDG: P, T
2. TPT: P, T
3. Upstream choke: P, T
4. Downstream choke: P

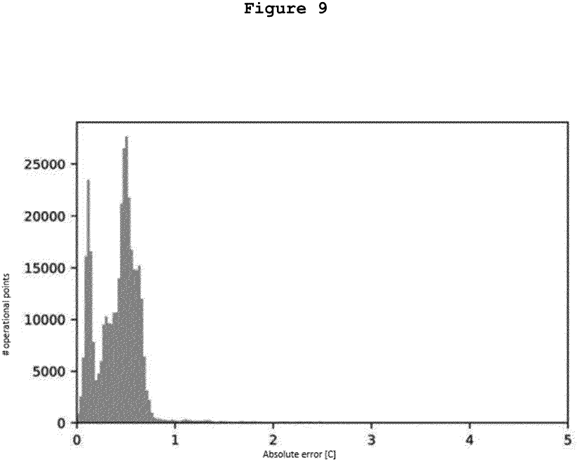

The output variable was PDG: T. Training data refer to the period from Jan. 01, 2019 to Oct. 08, 2020 (1 year and 9 months). Training data referred to the period from Jan. 01, 2017 to May 18, 2018 (1 year and 3 months). Test data 1 (T_TPT functional) referred to the period from May 18, 2018 to Sep. 21, 2018 (4 months) and test data 2 (T_TPT failure) referred to Jan. 01, 2021 - Mar. 26, 2021 (3 months). The acquisition rate was 1/30 S/s. The model was the LSTM (tanh, sigmoid, 20 neurons), MLP (linear, 100 neurons). FIG. 9 shows the histogram of the absolute error evaluated in test set 1. It shows that all points had absolute errors below 1 kgf/cm².

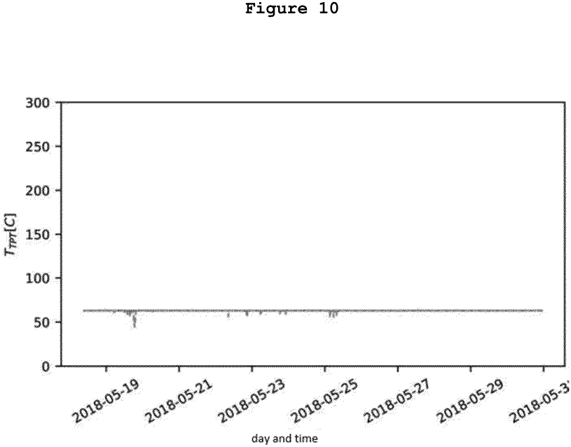

FIG. 10 shows the graph of temperature (°C) versus time (day and hour) with the actual (solid) and prediction (dotted) lines, showing that the method reproduces the actual temperature measurement.

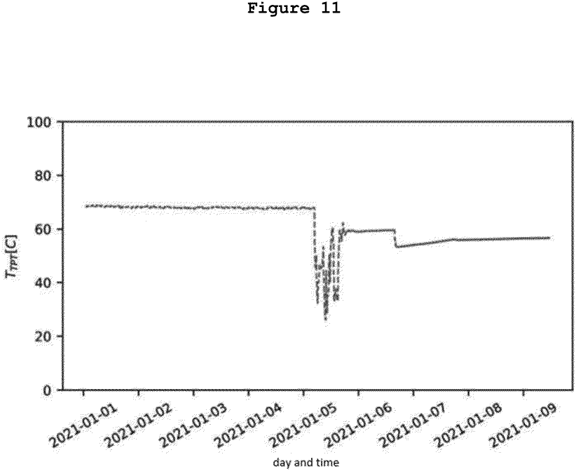

FIG. 11 shows the graph of temperature (°C) over time (day and hour) with real (solid) and predicted (dotted) lines, with data from test 2 (T_TPT failure): Jan. 01, 2021 - Mar. 26, 2021 (3 months). As can be seen, in this instance temperature monitoring is carried out only by the model.

An advantage of using the disclosed method for such a gas lift wellbore was the identification of transient regimes that could not be missed in the course of modeling.

1- A SIGNAL RECOVERY METHOD, characterized by comprising:
1- selecting the process measurement variable;
2- collecting historical measurement data of the process variable;
3- filtering spurious components and segmenting the samples into intervals with N data;
4- using the recurrent neural network layer connected to a multilayer perceptron layer;
5- using the recurrent network activation function through the hyperbolic tangent;
6- using the multilayer perceptron layer activation function through the linear type;
7- using the cross-validation method;
8- normalizing the filtered data;
9- using an optimization method for training the model;
10- using historians softwares to generate a sequence with input data referring to the time frame one wants the model to perform the prediction;
11- filtering said sequence to withdraw spurious components and segment the samples into N data intervals;
12- normalizing this sequence to the arithmetic mean and standard deviation;
13- displaying the sequence to the model;
14- assessing the occurrence of overlapping segments;
15- writing the results in a historian software-monitored variable or in a graph.

2- METHOD, according to claim 1, characterized in that the recurrent neural network layer is of the FRNN, or LSTM or GRU type.

3- METHOD, according to claim 1, characterized in that the neural network used in series with the recurrent neural network is of the MLP type - multilayer Perceptron, Support Vector Machine, Radial Basis Activation Function Neural Networks, Extreme Learning Machines, Echo State Neural Networks.

4- METHOD, according to claim 3, characterized in that the neural network used in series with the recurrent neural network is preferably of the MLP type - multilayer linear perceptron.

5- METHOD, according to claim 1, characterized in that the recurrent neural network layer has from 10 to 100 neurons.

6- METHOD, according to claim 5, characterized in that the recurrent neural network layer preferably has 30 neurons.

7- METHOD, according to claim 1, characterized in that the multilayer perceptron layer has from 50 to 400 neurons.

8- METHOD, according to claim 7, characterized in that the multilayer perceptron layer preferably has 100 neurons.

9- METHOD, according to claim 1, characterized in that the data acquisition frequency is from 1/60 to 10,000 samples per second.

10- METHOD, according to claim 9, characterized in that the data acquisition frequency is preferably 1/30 samples per second.

11- METHOD, according to claim 1, characterized in that the historical measurement data comprise a time frame of not less than 1 day.

12- METHOD, according to claim 1, characterized in that the N data comprise between 50 and 1,000 data.

13- METHOD, according to claim 12, characterized in that the N data preferably comprise 100 data.

14- METHOD, according to claim 1, characterized in that the cross-validation method is selected from among the holdout, k-fold or leave-one-out methods.

15- METHOD, according to claim 14, characterized in that the cross-validation method is preferably the holdout method.

16- METHOD, according to claim 1, characterized by normalizing the filtered data by the arithmetic mean and standard deviation, or between any two values, or by forcing the normal statistical distribution, or applying any linear transformation to the data such as main component analysis prior to training.

17- METHOD, according to claim 16, characterized in that it is preferably normalized by the arithmetic mean and standard deviation.

18- METHOD, according to claim 1, characterized in that when segments overlap, calculating the arithmetic mean, applying another linear meta model or a non-linear meta model.

19- METHOD, according to claim 18, characterized in that the linear meta model is a linear regression or a weighted average.

20- METHOD, according to claim 18, characterized in that the non-linear meta model is: neural network, support vector machine, radial basis activation function neural networks, Extreme Learning Machines, echo state neural networks and K-nearest neighbors.
